(19) United States
(12) Patent Application Publication
(10) Pub. No.: US 2010/0299132 A1
(43) Pub. Date: Nov. 25, 2010

(54) MINING PHRASE PAIRS FROM AN UNSTRUCTURED RESOURCE

(75) Inventors: William B. Dolan, Kirkland, WA (US); Christopher J. Brockett, Bellevue, WA (US); Julio J. Castillo, Redmond, WA (US); Lucretia H. Vanderwende, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/470,492

(22) Filed: May 22, 2009

(51) Int. Cl. G06F 17/28

(52) U.S. Cl. 704/2; 704/E15.003

(57) ABSTRACT

A mining system applies queries to retrieve result items from an unstructured resource. The unstructured resource may correspond to a repository of network-accessible resource items. The result items that are retrieved may correspond to text segments (e.g., sentence fragments) associated with resource items. The mining system produces a structured training set by filtering the result items and establishing respective pairs of result items. A training system can use the training set to produce a statistical translation model. The translation model can be used in a monolingual context to translate between semantically-related phrases in a single language. The translation model can also be used in a bilingual context to translate between phrases expressed in two respective languages. Various applications of the translation model are also described.

### BACKGROUND

There has been considerable interest in statistical machine translation technology in recent years. This technology operates by first establishing a training set. Traditionally, the training set provides a parallel corpus of text, such as a body of text in a first language and a corresponding body of text in a second language. A training module uses statistical techniques to determine the manner in which the first body of text most likely maps to the second body of text. This analysis results in the generation of a translation model. In a decoding stage, the translation model can be used to map instances of text in the first language to corresponding instances of text in the second language.

The effectiveness of a statistical translation model often depends on the robustness of the training set used to produce the translation model. However, it is a challenging task to provide a high quality training set. In part, this is because the training module typically requires a large amount of training data, yet there is a paucity of pre-established parallel corpora-type resources for supplying such information. In a traditional case, a training set can be obtained by manually generating parallel texts, e.g., through the use of human translators. The manual generation of these texts, however, is an enormously time-consuming task.

A number of techniques exist to identify parallel texts in a more automated manner. Consider, for example, the case in which a web site conveys the same information in multiple different languages, each version of the information being associated with a separate network address (e.g., a separate URL). In one technique, a retrieval module can examine a search index in attempt to identify these parallel documents, e.g., based on characteristic information within the URLs. However, this technique may provide access to a relatively limited number of parallel texts. Furthermore, this approach may depend on assumptions which may not hold true in many cases.

The above examples have been framed in the context of a model which converts text between two different natural languages. Monolingual models have also been proposed. Such models attempt to rephrase input text to produce output text in the same language as the input text. In one application, for example, this type of model can be used to modify a user's search query, e.g., by identifying additional ways to express the search query.

A monolingual model is subject to the same shortcomings noted above. Indeed, it may be especially challenging to find pre-existing parallel corpora within the same language. That is, in the bilingual context, there is a preexisting need to generate parallel texts in different languages to accommodate the native languages of different readers. There is a much more limited need to generate parallel versions of text in the same language.

Nevertheless, such monolingual information does exist in small amounts. For example, a conventional thesaurus provides information regarding words in the same language with similar meaning. In another case, some books have been translated into the same language by different translators. The different translations may serve as parallel monolingual corpora. However, this type of parallel information may be too specialized to be effectively used in more general contexts. Further, as stated, there is only a relatively small amount of this type of information.

Attempts have also been made to automatically identify a body of monolingual documents pertaining to the same topic, and then mine these documents for the presence of parallel sentences. However, in some cases, these approaches have relied on context-specific assumptions which may limit their effectiveness and generality. In addition to these difficulties, text can be rephrased in a great variety of ways; thus, identifying parallelism in a monolingual context is potentially a more complex task than identifying related text in a bilingual context.

### SUMMARY

A mining system is described herein which culls a structured training set from an unstructured resource. That is, the unstructured resource may be latently rich in repetitive content and alternation-type content. Repetitive content means that the unstructured resource includes many repetitions of the same instances of text. Alternation-type content means that the unstructured resource includes many instances of text that differ in form but express similar semantic content. The mining system exposes and extracts these characteristics of the unstructured resource, and through that process, transforms raw unstructured content into structured content for use in training a translation model. In one case, the unstructured resource may correspond to a repository of network-accessible resource items (e.g., Internet-accessible resource items).

According to one illustrative implementation, a mining system operates by submitting queries to a retrieval module. The retrieval module uses to the queries to conduct a search within the unstructured resource, upon which it provides result items. The result items may correspond to text segments which summarize associated resource items provided in the unstructured resource. The mining system produces the structured training set by filtering the result items and identifying respective pairs of result items. A training system can use the training set to produce a statistical translation model.

According to one illustrative aspect, the mining system may identify result items based solely on the submission of queries, without pre-identifying groups of resource items that address the same topic. In other words, the mining system can take an agnostic approach regarding the subject matter of the resource items (e.g., documents) as a whole; the mining system exposes structure within the unstructured resource on a sub-document snippet level.

According to another illustrative aspect, the training set can include items corresponding to sentence fragments. In other words, the training system does not rely on the identification and exploitation of sentence-level parallelism (although the training system can also successfully process training sets that include full sentences).

According to another illustrative aspect, the translation model can be used in a monolingual context to convert an input phrase into an output phrase within a single language, where the input phrase and the output phrase have similar semantic content but have different forms of expression. In other words, the translation model can be used to provide a paraphrased version of an input phrase. The translation model can also be used in a bilingual context to translate an input phrase in a first language to an output phrase in a second language.

According to another illustrative aspect, various applications of the translation model are described.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative system for creating and applying a statistical machine translation model.

FIG. 2 shows an implementation of the system of FIG. 1 within a network-related environment.

FIG. 3 shows an example of a series of result items within one result set. The system of FIG. 1 returns the result set in response to the submission of a query to a retrieval module.

FIG. 4 shows an example which demonstrates how the system of FIG. 1 can establish pairs of result items within a result set.

FIG. 5 shows an example which demonstrates how the system of FIG. 1 can create a training set based on analysis performed with respect to different result sets.

FIG. 6 shows an illustrative procedure that presents an overview of the operation of the system of FIG. 1.

FIG. 7 shows an illustrative procedure for establishing a training set within the procedure of FIG. 6.

FIG. 8 shows an illustrative procedure for applying a translation model created using the system of FIG. 1.

FIG. 9 shows illustrative processing functionality that can be used to implement any aspect of the features shown in the foregoing drawings.

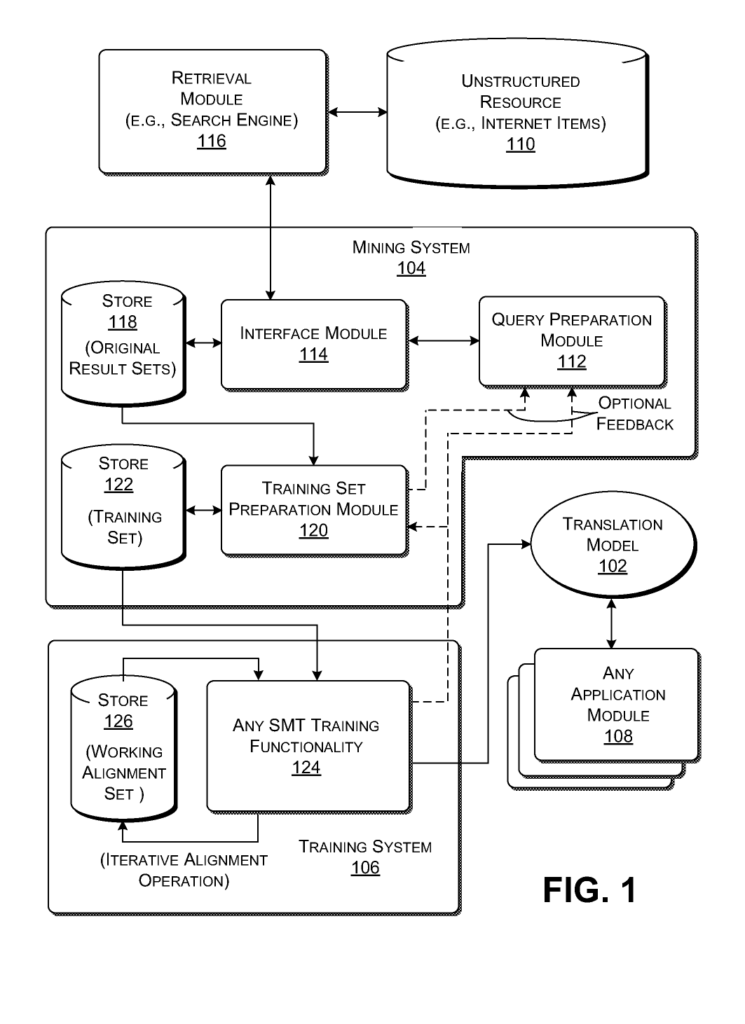

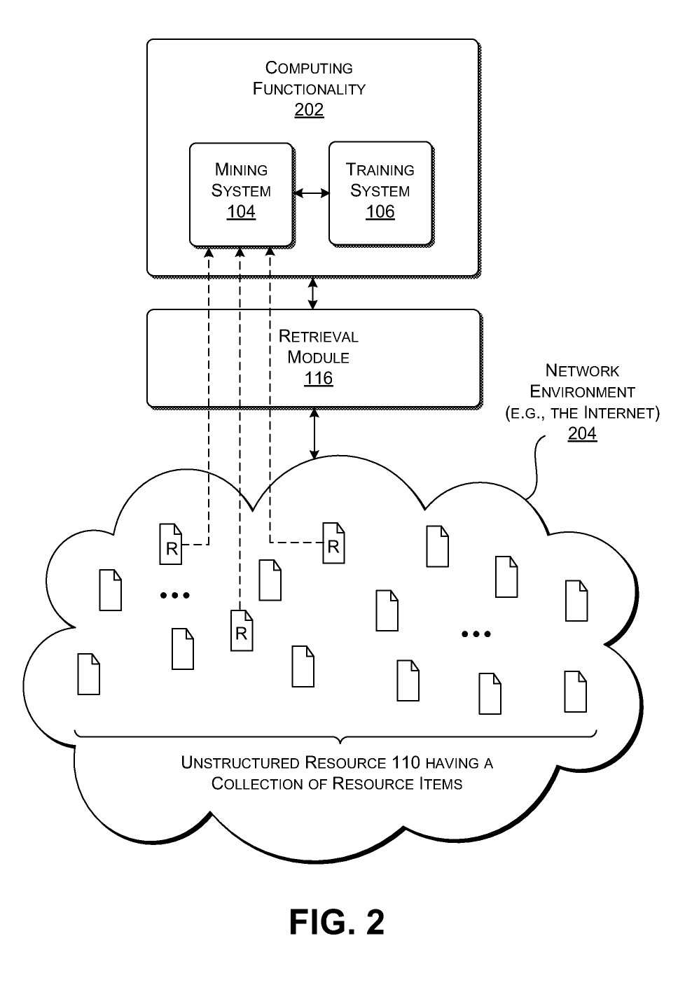

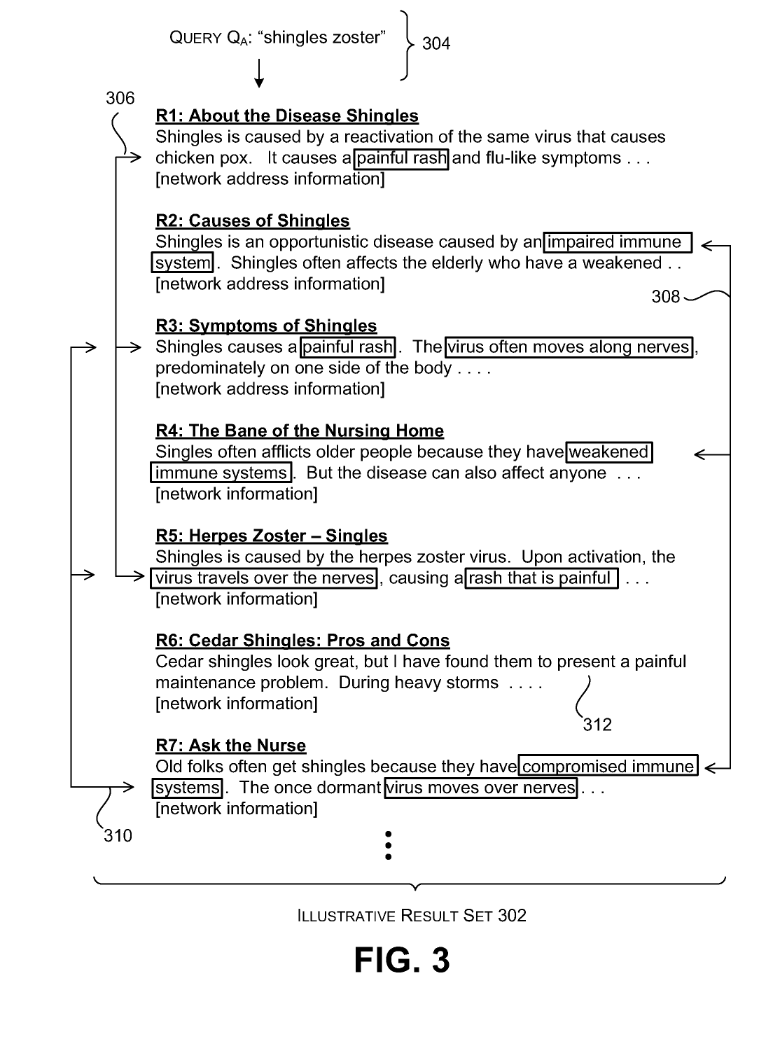

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth functionality for generating a training set that can be used to establish a statistical translation model. The disclosure also sets forth functionality for generating and applying the statistical translation model.

This disclosure is organized as follows. Section A describes an illustrative system for performing the functions summarized above. Section B describes illustrative methods which explain the operation of the system of Section A. Section C describes illustrative processing functionality that can be used to implement any aspect of the features described in Sections A and B.

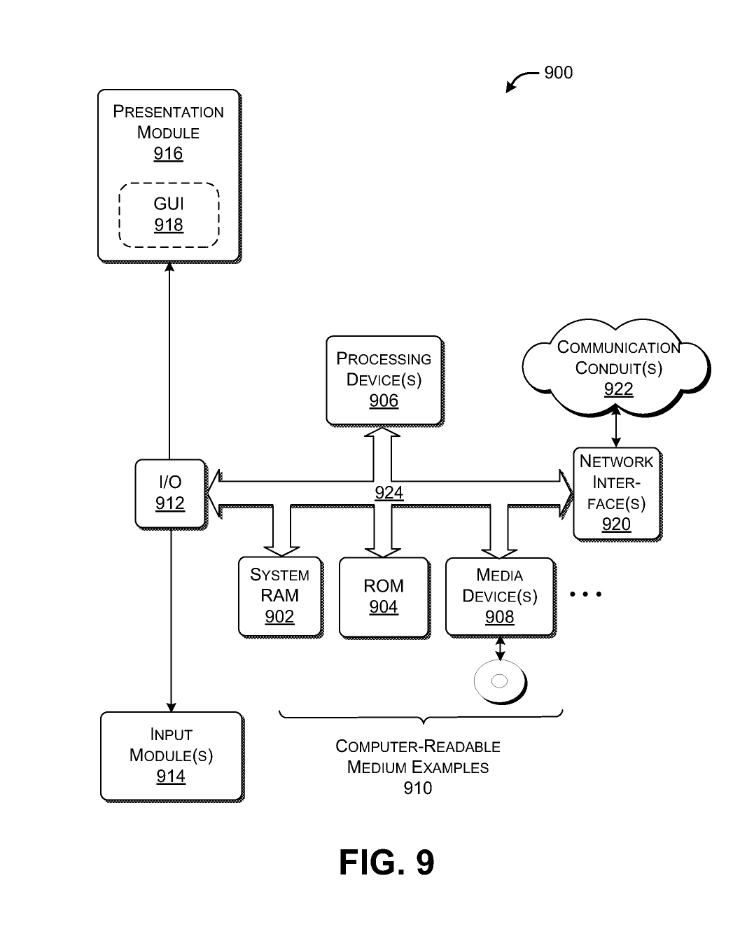

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 9, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

As to terminology, the phrase “configured to” encompasses any way that any kind of functionality can be constructed to perform an identified operation. The functionality can be configured to perform an operation using, for instance, software, hardware (e.g., discrete logic components, etc.), firmware etc., and/or any combination thereof.

The term “logic” encompasses any functionality for performing a task. For instance, each operation illustrated in the flowcharts corresponds to logic for performing that operation. An operation can be performed using, for instance, software, hardware (e.g., discrete logic components, etc.), firmware, etc., and/or any combination thereof.

A. Illustrative Systems

FIG. 1 shows an illustrative system 100 for generating and applying a translation model 102. The translation model 102 corresponds to a statistical machine translation (SMT) model for mapping an input phrase to an output phrase, where “phrase” here refers to any one or more text strings. The translation model 102 performs this operation using statistical techniques, rather than a rule-based approach. However, in another implementation, the translation model 102 can supplement its statistical analysis by incorporating one or more features of a rules-based approach.

In one case, the translation model 102 operates in a monolingual context. Here, the translation model 102 generates an output phrase that is expressed in the same language as the input phrase. In other words, the output phrase can be considered a paraphrased version of the input phrase. In another case, the translation model 102 operates in a bilingual (or multilingual) context. Here, the translation model 102 generates an output phrase in a different language compared to the input phrase. In yet another case, the translation model 102 operates in a transliteration context. Here, the translation model generates an output phrase in the same language as the input phrase, but the output phrase is expressed in a different writing form compared to the input phrase. The translation model 102 can be applied to yet other translation scenarios. In all such contexts, the word “translation” is to be construed broadly, referring to any type of conversation of textual information from one state to another.

The system 100 includes three principal components: a mining system 104; a training system 106; and an application module 108. By way of overview, the mining system 104 produces a training set for use in training the translation model 102. The training system 106 applies an iterative approach to derive the translation model 102 on the basis of the training set. And the application module 108 applies the translation model 102 to map an input phrase into an output phrase in a particular use-related scenario.

In one case, a single system can implement all of the components shown in FIG. 1, as administered by a single entity or any combination of plural entities. In another case, any two or more separate systems can implement any two or more components shown in FIG. 1, again, as administered by a single entity or any combination of plural entities. In either case, the components shown in FIG. 1 can be located at a single site or distributed over plural respective sites. The following explanation provides additional details regarding the components shown in FIG. 1.

Beginning with the mining system 104, this component operates by retrieving result items from an unstructured resource 110. The unstructured resource 110 represents any localized or distributed source of resource items. The resource items, in turn, may correspond to any units of textual information. For example, the unstructured resource 110 may represents a distributed repository of resource items provided by a wide area network, such as the Internet. Here, the resource items may correspond to network-accessible pages and/or associated documents of any type.

The unstructured resource 110 is considered unstructured because it is not a priori arranged in the manner of a parallel corpora. In other words, the unstructured resource 110 does not relate its resource items to each other according to any overarching scheme. Nevertheless, the unstructured resource 110 may be latently rich in repetitive content and alternation-type content. Repetitive content means that the unstructured resource 110 includes many repetitions of the same instances of text. Alternation-type content means that the unstructured resource 110 includes many instances of text that differ in form but express similar semantic content. This means that there are underlying features of the unstructured resource 110 that can be mined for use in constructing a training set.

One purpose of the mining system 104 is to expose the above-described characteristics of the unstructured resource 110, and through that process, transform the raw unstructured content into structured content for use in training the translation model 102. The mining system 104 accomplishes this purpose, in part, using a query preparation module 112 and an interface module 114, in conjunction with a retrieval module 116. The query preparation module 112 formulates a group of queries. Each query may include one or more query terms directed towards a target subject. The interface module 114 submits the queries to the retrieval module 116. The retrieval module 116 uses the queries to perform a search within the unstructured resource 110. In response to this search, the retrieval module 116 returns a plurality of result sets for the different respective queries. Each result set, in turn, includes one or more result items. The result items identify respective resource items within the unstructured resource 110.

In one case, the mining system 104 and the retrieval module 116 are implemented by the same system, administered by the same entity or different respective entities. In another case, the mining system 104 and the retrieval module 116 are implemented by two respective systems, again, administered by the same entity or different respective entities. For example, in one implementation, the retrieval module 116 represents a search engine, such as, but not limited to, the Live Search engine provided by Microsoft Corporation of Redmond, Wash. A user may access the search engine through any mechanism, such as an interface provided by the search engine (e.g., an API or the like). The search engine can identify and formulate a result set in response to a submitted query using any search strategy and ranking strategy.

In one case, the result items in a result set correspond to respective text segments. Different search engines may use different strategies in formulating text segments in response to the submission of a query. In many cases, the text segments provide representative portions (e.g., excerpts) of the resource items that convey the relevance of the resource items vis-à-vie the submitted queries. For purposes of explanation, the text segments can be considered brief abstracts or summaries of their associated complete resource items. More specifically, in one case, the text segments may correspond to one or more sentences taken from the underlying full resource items. In one scenario, the interface module 114 and retrieval module 116 can formulate resource items that include sentence fragments. In another scenario, the interface module 114 and retrieval module 116 can formulate resource items that include full sentences (or larger units of text, such as full paragraphs or the like). The interface module 114 stores the result sets in a store 118.

A training set preparation module 120 (“preparation module” for brevity) processes the raw data in the result sets to produce a training set. This operation includes two component operations, namely, filtering and matching, which can be performed separately or together. As to the filtering operation, the preparation module 120 filters the original set of result items based on one or more constraining consideration. The aim of this processing is to identify a subset of result items that are appropriate candidates for pairwise matching, thereby eliminating “noise” from the result sets. The filtering operation produces filtered result sets. As to the matching operation, the preparation module 120 performs pairwise matching on the filtered result sets. The pairwise matching identifies pairs of result items within the result sets. The preparation module 120 stores the training set produced by the above operations within a store 122. Additional details regarding the operation of the preparation module 120 will be provided at a later juncture of this explanation.

The training system 106 uses the training set in the store 122 to train the translation model 102. To this end, the training system 106 can include any type of statistical machine translation (SMT) functionality 124, such as phrase-type SMT functionality. The SMT functionality 124 operates by using statistical techniques to identify patterns in the training set. The SMT functionality 124 uses these patterns to identify correlations of phrases within the training set.

More specifically, the SMT functionality 124 performs its training operation in an iterative manner. At each stage, the SMT functionality 124 performs statistical analysis which allows it to reach tentative assumptions as to the pairwise alignment of phrases in the training set. The SMT functionality 124 uses these tentative assumptions to repeat its statistical analysis, allowing it to reach updated tentative assumptions. The SMT functionality 124 repeats this iterative operation until a termination condition is deemed satisfied. A store 126 can maintain a working set of provisional alignment information (e.g., in the form of a translation table or the like) over the course of the processing performed by the SMT functionality 124. At the termination of its processing, the SMT functionality 124 produces statistical parameters which define the translation model 102. Additional details regarding the SMT functionality 124 will be provided at a later juncture of this explanation.

The application module 108 uses the translation model 102 to convert an input phrase into a semantically-related output phrase. As noted above, the input phrase and the output phrase can be expressed in the same language or different respective languages. The application module 108 can perform this conversion in the context of various application scenarios. Additional details regarding the application module 108 and the application scenarios will be provided at a later juncture of this explanation.

FIG. 2 shows one representative implementation of the system 100 of FIG. 1. In this case, computing functionality 202 can be used to implement the mining system 104 and the training system 106. The computing functionality 202 can represent any processing functionality maintained at a single site or distributed over plural sites, as maintained by a single entity or a combination of plural entities. In one representative case, the computing functionality 202 corresponds to any type of computer device, such personal desktop computing device, a server-type computing device, etc.

In one case, the unstructured resource 110 can be implemented by a distributed repository of resource items provided by a network environment 204. The network environment 204 may correspond to any type of local area network or wide area network. For example, without limitation, the network environment 204 may correspond to the Internet. Such an environment provides access to a potentially vast number of resource items, e.g., corresponding to network-accessible pages and linked content items. The retrieval module 116 can maintain an index of the available resource items in the network environment 204 in a conventional manner, e.g., using network crawling functionality or the like.

FIG. 3 shows an example of part of a hypothetical result set 302 that can be returned by the retrieval module 116 in response to the submission of a query 304. This example serves as a vehicle for explaining some of the conceptual underpinnings of the mining system 104 of FIG. 1.

The query 304, “shingles zoster,” is directed to a well known disease. The query is chosen to pinpoint the targeted subject matter with sufficient focus to exclude a great amount of extraneous information. In this example, “shingles” refers to the common name of the disease, whereas “zoster” (e.g., as in herpes zoster) refers to the more formal name of the disease. This combination of query terms may thus reduce the retrieval of result items that pertain to extraneous and unintended meanings of the word “shingles.”

The result set 302 includes a series of result items, labeled as R1-RN; FIG. 3 shows a small sample of these result items. Each result item includes a text segment that is extracted from a corresponding resource item. In this case, the text segments include sentence fragments. But the interface module 114 and the retrieval module 116 can also be configured to provide resource items that include full sentences (or full paragraphs, etc.).

The disease of shingles has salient characteristics. For example, shingles is a disease which is caused by a reactivation of the same virus (herpes zoster) that causes chicken pox. Upon being reawakened, the virus travels along the nerves of the body, leading to a painful rash that is reddish in appearance, and characterized by small clusters of blisters. The disease often occurs when the immune system is compromised, and thus can be triggered by physical trauma, other diseases, stress, and so forth. The disease often afflicts the elderly, and so on.

Different result items can be expected to include content which focuses on the salient characteristics of the disease. And as a consequence, the result items can be expected to repeat certain telltale phrases. For example, as indicated by instances 306, several of the result items mention the occurrence of a painful rash, as variously expressed. As indicated by instances 308, several of the result items mention that that the disease is associated with a weakened immune system, as variously expressed. As indicated by instances 310, several of the result items mention that the disease results in the virus moving along nerves in the body, as variously expressed, and so on. These examples are merely illustrative. Other result items may be largely irrelevant to the targeted subject. For example, result item 312 uses in the term “shingles” in the context of a building material, and is therefore not germane to the topic. But even this extraneous result item 312 may include phrases which are shared with other result items.

Various insights can be gleaned from the patterns manifested in the result set 302. Some of these insights narrowly pertain to the targeted subject, namely, the disease of shingles. For example, the mining system 104 can use the result set 302 to infer that “shingles” and “herpes zoster” are synonyms. Other insights pertain to the medical field in general. For example, the mining system 104 can infer that the phrase “painful rash” can be meaningfully substituted for the phrase “a rash that is painful.” Further the mining system 104 can infer that the phrase “impaired” can be meaningfully replaced with “weakened” or “compromised” when discussing the immune system (and potentially other subjects). Other insights may have global or domain-independent reach. For example, the mining system 104 can infer that the phrase “moves along” may be meaningfully substituted for “travels over” or “moves over,” and that the phrase “elderly” can be replaced with “old people,” or “old folks,” or “senior citizens,” and so on. These equivalencies are exhibited in a medical context within the result set 302, but they may apply to other contexts. For example, one might describe one's trip to work as either “travelling over” a roadway or “moving along” the roadway.

FIG. 3 is also useful for illustrating one mechanism by which the training system 106 can identify meaningful similarity among phrases. For example, the result items repeat many of the same words, such as “rash,” “elderly,” “nerves,” “immune system,” and so on. These frequently-appearing words can serve as anchor points to investigate the text segments for the presence of semantically-related phrases. For example, by focusing on the anchor point associated with the commonly-occurring phrase “immune system,” the training system 106 can derive the conclusion that “impaired,” “weakened,” and “compromised” may correspond to semantically-exchangeable words. The training system 106 can approach this investigation in a piecemeal fashion. That is, it can derive tentative assumptions regarding the alignment of phrases. Based on those assumptions, it can repeat its investigation to derive new tentative assumptions. At any juncture, the tentative assumptions may enable the training system 106 to derive additional insight into the relatedness of result items; alternatively, the assumptions may represent a step back, obfuscating further analysis (in which case, the assumptions can be revised). Through this process, the training system 106 attempts to arrive at a stable set of assumptions regarding the relatedness of phrases within a result set.

More generally, this example also illustrates that the mining system 104 may identify result items based solely on the submission of queries, without pre-identifying groups of resource items (e.g., underlying documents) that address the same topic. In other words, the mining system 104 can take an agnostic approach regarding the subject matter of the resource items as a whole. In the example of FIG. 3, most of the resource items likely do in fact pertain to the same topic (the disease shingles). However, (1) this similarity is exposed on the basis of the queries alone, rather than a meta-level analysis of documents, and (2) there is no requirement that the resource items pertain to the same topic.

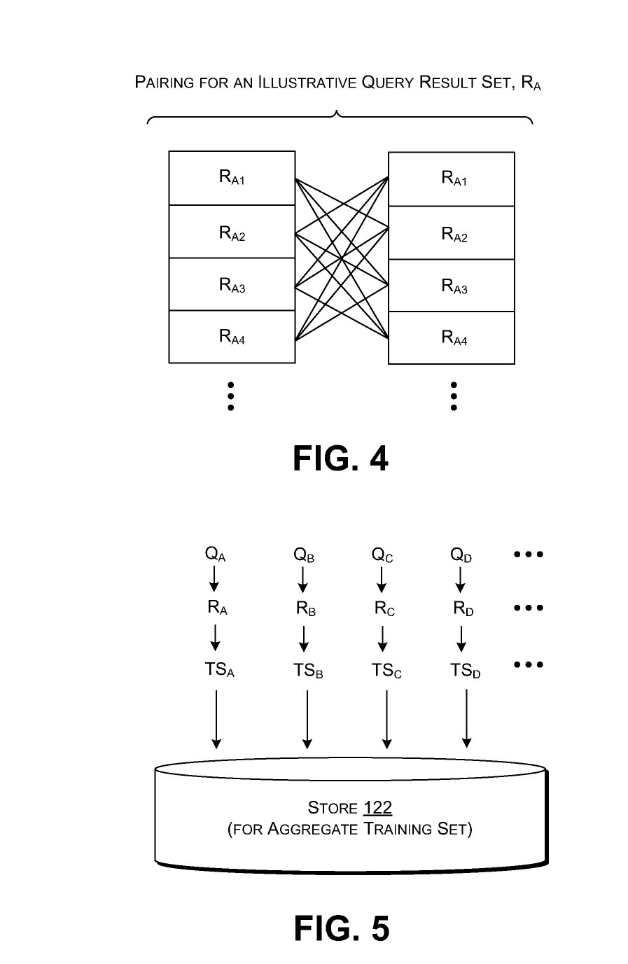

Advancing to FIG. 4, this figure shows the manner in which the preparation module 120 (of FIG. 1) can be used to establish an initial pairing of result items (R_{A1}-R_{AN}) within a result set (R_{A}). Here, the preparation module 120 can establish links between each result item and every other result item in the result set (excluding self-identical pairings of result items). For example, a first pair connects result item R_{A1} with result item R_{A2}. A second pair connects result item R_{A1} with result item R_{A3}, and so on. In practice, the preparation module 120 can constrain the associations between result items based one or more filtering considerations. Section B will provide additional information regarding the manner in which the preparation module 120 can constrain the pairwise matching of result items.

To repeat, the result items that are paired in the above manner may correspond to any portion of their respective resource items, including sentence fragments. This means that the mining system 104 can establish the training set without the express task of identifying parallel sentences. In other words, the training system 106 does not depend on the exploitation of sentence-level parallelism. However, the training system 106 can also successfully process a training set in which the result items include full sentences (or larger units of text).

FIG. 5 illustrates the manner in which pairwise mappings from different result sets can be combined to form the training set in the store 122. That is, query Q_{A} leads to result set R_{A}, which, in turn, leads to a pairwise-matched result set TS_{A}. Query Q_{B} lead to result set R_{B}, which, in turn, leads to a pairwise-matched result set TS_{B}, and so on. The preparation module 120 combines and concatenates these different pairwise-matched result sets to create the training set. As a whole, the training set establishes an initial set of provisional alignments between result items for further investigation. The training system 106 operates on the training set in an iterative manner to identify a subset of alignments which reveal truly related text segments. Ultimately, the training system 106 seeks to identify semantically-related phrases that are exhibited within the alignments.

As a final point in this section, note that, in FIG. 1, dashed lines are drawn between different components of the system 100. This graphically represents that conclusions reached by any component can be used to modify the operation of other components. For example, the SMT functionality 124 can reach certain conclusions that have a bearing on the way that the preparation module 120 performs its initial filtering and pairing of the result sets. The preparation module 120 can receive this feedback and modify its filtering or matching behavior in response thereto. In another case, the SMT functionality 124 or the preparation module 120 can reach conclusions regarding the effectiveness of certain query formulation strategies, e.g., as bearing on the ability of the query formulation strategies to extract result sets that are rich in repetitive content and alternation-type content. The query preparation module 112 can receive this feedback and modify its behavior in response thereto. More particularly, in one case, the SMT functionality 124 or the preparation module 120 can discover a key term or key phrase that may be useful to include within another round of queries, leading to additional result sets for analysis. Still other opportunities for feedback may exist within the system 100.

B. Illustrative Processes

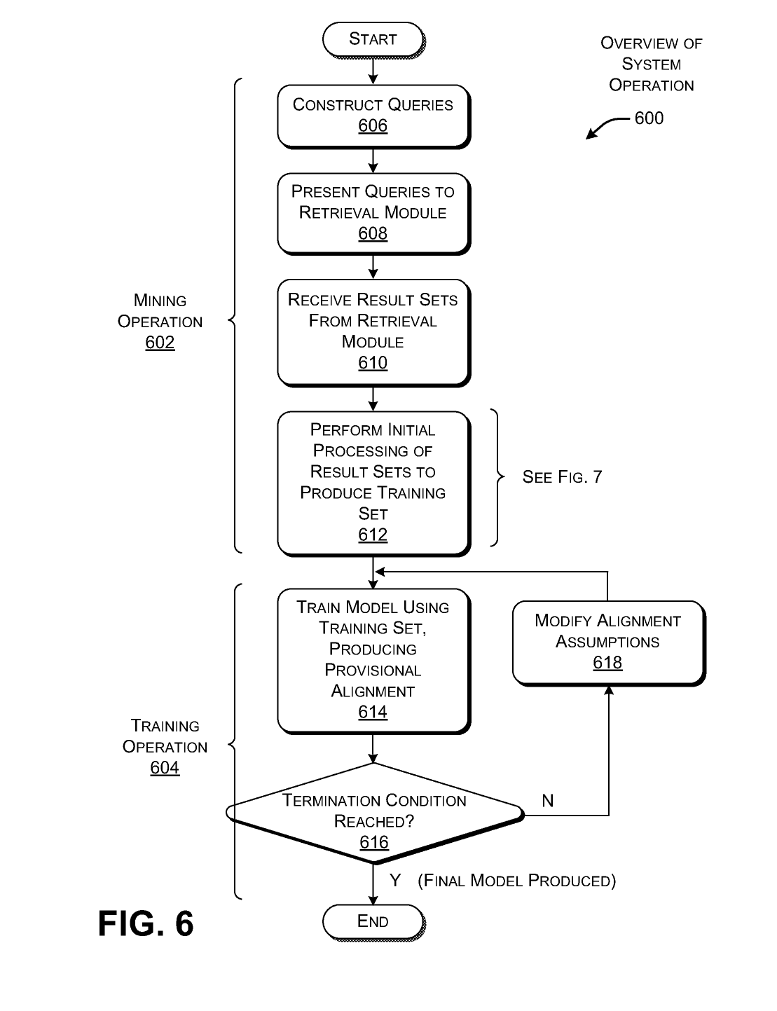

FIGS. 6-8 show procedures (600, 700, 800) that explain one manner of operation of the system 100 of FIG. 1. Since the principles underlying the operation of the system 100 have already been introduced in Section A, certain operations will be addressed in summary fashion in this section.

Starting with FIG. 6, this figure shows a procedure 600 which represents an overview of the operation of the mining system 104 and the training system 106. More specifically, a first phase of operations describes a mining operation 602 performed by the mining system 104, while a second phase of operations describes a training operation 604 performed by the training system 106.

In block 606, the mining system 104 initiates the process 600 by constructing a set of queries. The mining system 104 can use different strategies to perform this task. In one case, the mining system 104 can extract a set of actual queries previously submitted by users to a search engine, e.g., as obtained from a query log or the like. In another case, the mining system 104 can construct “artificial” queries based on any reference source or combination of reference sources. For example, the mining system 104 can extract query terms from the classification index of an encyclopedic reference source, such as Wikipedia or the like, or from a thesaurus, etc. To cite merely one example, the mining system 104 can use a reference source to generate a collection of queries that include different disease names. The mining system 104 can supplement the disease names with one or more other terms to help focus the result sets that are returned. For example, the mining system 104 can conjoin each common disease name with its formal medical equivalent, as in “shingles AND zoster.” Or the mining system 104 can conjoin each disease name with another query term which is somewhat orthogonal to the disease name, such as “shingles AND prevention,” and so on.

More broadly considered, the query selection in block 606 can be governed by different overarching objectives. In one case, the mining system 104 may attempt to prepare queries that focus on a particular domain. This strategy may be effective in surfacing phrases that are somewhat weighted toward that particular domain. In another case, the mining system 104 can attempt to prepare queries that canvass a broader range of domains. This strategy may be effective in surfacing phrases that are more domain-independent in nature. In any case, the mining system 104 seeks to obtain result items that are both rich in repetitive content and alternation-type content, as discussed above. Further, the queries themselves remain the primary vehicle to extract parallelism from the unstructured resource, rather than any type of a priori analysis of similar topics among resource items.

Finally, the mining system 104 can receive feedback which reveals the effectiveness of its choice of queries. Based on this feedback, the mining system 104 can modify the rules which govern how it constructs queries. In addition, the feedback can identify specific keyword or key phrases that can be used to formulate queries.

In block 608, the mining system 104 submits the queries to the retrieval module 116. The retrieval module 116, in turn, uses the queries to perform a search operation within the unstructured resource 110.

In block 610, the mining system 104 receives result sets back from the retrieval module 116. The result sets include respective groups of result items. Each result item may correspond to a text segment extracted from a corresponding resource item within the unstructured resource 110.

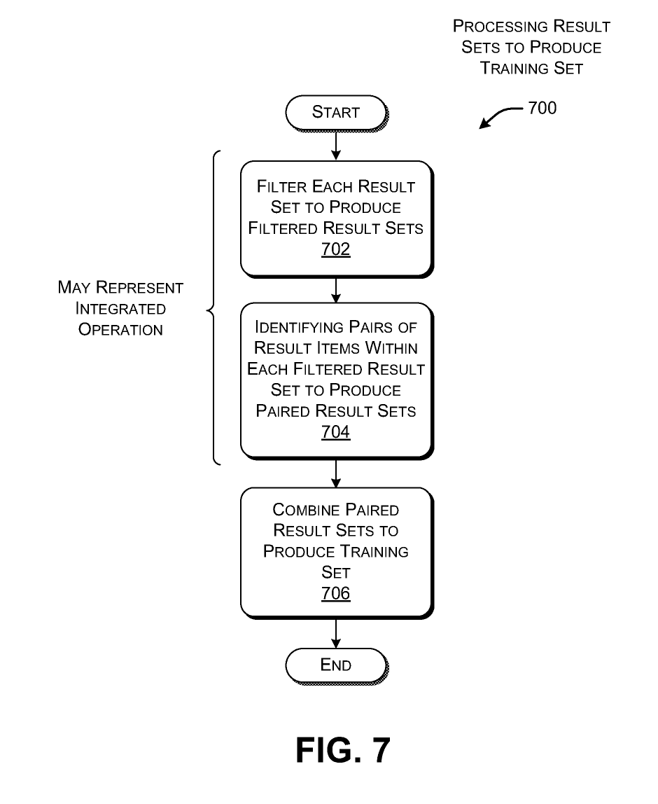

In block 612, the mining system 104 performs initial processing of the result sets to produce a training set. As described above, this operation can include two components. In a filtering component, the mining system 104 constrains the result sets to remove or marginalize information that is not likely to be useful in identifying semantically-related phrases. In a matching component, the mining system 104 identifies pairs of result items, e.g., on a set-by-set basis. FIG. 4 graphically illustrates this operation in the context of an illustrative result set. FIG. 7 provides additional details regarding the operations performed in block 612.

In block 614, the training system 106 uses statistical techniques to operate on the training set to derive the translation model 102. Any statistical machine translation approach can be used to perform this operation, such as any type of phrase-oriented approach. Generally, the translation model 102 can be represented as P(y|x), which defines the probability that an output phrase y represents a given input phrase x. Using Bayes rule, this can be expressed as P(y|x)=P(x|y)P(y)/P(x). The training system 106 operates to uncover the probabilities defined by this expression based on an investigation of the training set, with the objective of learning mappings from input phrase x that tend to maximize P(x|y)P(y). As noted above, the investigation is iterative in nature. At each stage of operation, the training system 106 can reach tentative conclusions regarding the alignment of phrases (and text segments as a whole) within the training set. In a phrase-oriented SMT approach, the tentative conclusions can be expressed using a translation table or the like.

In block 616, the training system 616 determines whether a termination condition has been reached, indicating that satisfactory alignment results have been achieved. Any metric can be used to make this determination, such as the well known Bilingual Evaluation Understudy (BLEU) score.

In block 618, if satisfactory results have not yet been achieved, the training system 106 modifies any of its assumptions used in training. This has the effect of modifying the prevailing working hypotheses regarding how phrases within the result items are related to each other (and how text segments as a whole are related to each other).

When the termination condition has been satisfied, the training system 106 will have identified mappings between semantically-related phrases within the training set. The parameters which define these mappings establish the translation model 102. The presumption which underlies the use of such a translation model 102 is that newly-encountered instances of text will resemble the patterns discovered within the training set.

The procedure of FIG. 6 can be varied in different ways. For example, in an alternative implementation, the training operation in block 614 can use a combination of statistical analysis and rules-based analysis to derive the translation model 102. In another modification, the training operation in block 614 can break the training task into plural subtasks, creating, in effect, plural translation models. The training operation can then merge the plural translation models into the single translation model 102. In another modification, the training operation in block 614 can be initialized or “primed” using a reference source, such as information obtained from a thesaurus or the like. Still other modifications are possible.

FIG. 7 shows a procedure 700 which provides additional detail regarding the filtering and matching processing performed by the mining system 104 in block 612 of FIG. 6.

In block 702, the mining system 104 filters the original result sets based on one or more considerations. This operation has the effect of identifying a subset of result items that are deemed the most appropriate candidates for pairwise matching. This operation helps reduce the complexity of the training set and the amount of noise in the training set (e.g., by eliminating or marginalizing result items assessed as having low relevance).

In one case, the mining system 104 can identify result items as appropriate candidates for pairwise matching based on ranking scores associated with the result items. Stated in the negative, the mining system 104 can remove result items that have ranking scores below a prescribed relevance threshold.

Alternatively, or in addition, the mining system 104 can generate lexical signatures for the respective result sets that express typical textual features found within the result sets (e.g., based on the commonality of words that appear in the result sets). The mining system 104 can then compare each result item with the lexical signature associated with its result set. The mining system 104 can identify result items as appropriate candidates for pairwise matching based this comparison. Stated in the negative, the mining system 104 can remove result items that differ from their lexical signatures by a prescribed amount. Less formally stated, the mining system 104 can remove result items that “stand out” within their respective result sets.

Alternatively, or in addition, the mining system 104 can generate similarity scores which identify how similar each result item is with respect each other result item within a result set. The mining system 104 can rely on any similarity metric to make this determination, such as, but not limited to, a cosine similarity metric. The mining system 104 can identify result items as appropriate candidates for pairwise matching based on these similarity scores. Stated in the negative, the mining system 104 can identify pairs of result items that are not good candidates for matching because they differ from each other by more than a prescribed amount, as revealed by the similarity scores.

Alternatively, or in addition, the mining system 104 can perform cluster analysis on result items within a result set to determine groups of similar result items, e.g., using the k-nearest neighbor clustering technique or any other clustering technique. The mining system 104 can then identify result items within each cluster as appropriate candidates for pairwise matching, but not candidates across different clusters.

The mining system 104 can perform yet other operations to filter or “clean up” the result items collected from the unstructured resource 110. Block 702 results in the generation of filtered result sets.

In block 704, the mining system 104 identifies pairs within the filtered result sets. As already discussed, FIG. 4 shows how this operation can be performed within the context of an illustrative result set.

In block 706, the mining system 104 can combine the results of block 704 (associated with individual result sets) to provide the training set. As already discussed, FIG. 5 shows how this operation can be performed.

Although block 704 is shown as separate from block 702 to facilitate explanation, blocks 702 and 704 can be performed as an integrated operation. Further, the filtering and matching operations of blocks 702 and 704 can be distributed over plural stages of the operation. For example, the mining system 104 can perform further filtering on the result items following block 706. Further, the training system 106 can perform further filtering on the result items in the course of its iterative processing (as represented by blocks 614-618 of FIG. 6).

As another variation, block 704 was described in the context of establishing pairs of result items within individual result sets. However, in another mode, the mining system 104 can establish candidate pairs across different result sets.

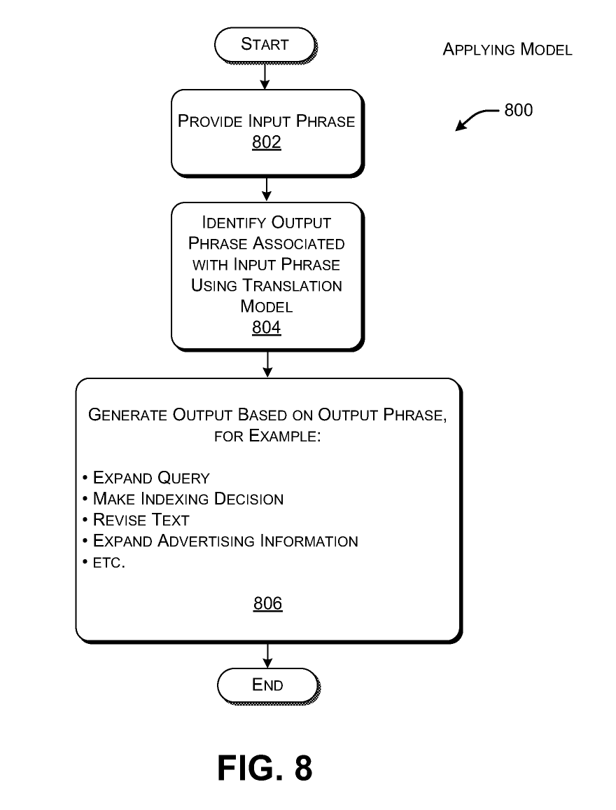

FIG. 8 shows a procedure 800 which describes illustrative applications of the translation model 102.

In block 802, the application module 108 receives an input phrase.

In block 804, the application module 108 uses the translation model 102 to convert the input phrase into an output phrase.

In block 806, the application module 108 generates an output result based on the output phrase. Different application modules can provide different respective output results to achieve different respective benefits.

In one scenario, the application module 108 can perform a query modification operation using the translation model 102. Here, the application module 108 treats the input phrase as a search query. The application module 108 can use the output phrase to replace or supplement the search query. For example, if the input phrase is “shingles,” the application module 108 can use the output phrase “zoster” to generate a supplemented query of “shingles AND zoster.” The application module 108 can then present the expanded query to a search engine.

In another scenario, the application module 108 can make an indexing classification decision using the translation model 102. Here, the application module 108 can extract any text content from a document to be classified and treat that text content as the input phrase. The application module 108 can use the output phrase to glean additional insight regarding the subject matter of the document, which, in turn, can be used to provide an appropriate classification of the document.

In another scenario, the application module 108 can perform any type of text revision operation using the translation model 102. Here, the application module 108 can treat the input phrase as a candidate for text revision. The application module 108 can use the output phrase to suggest a way in which the input phrase can be revised. For example, assume that the input phrase corresponds to the rather verbose text “rash that is painful.” The application module 108 can suggest that this input phrase can be replaced with the more succinct “painful rash.” In making this suggestion, the application module 108 can rectify any grammatical and/or spelling errors in the original phrase (presuming that the output phrase does not contain grammatical and/or spelling errors). In one case, the application module 108 can offer the user multiple choices as to how he or she may revise an input phrase, coupled with some type of information that allows the user to gauge the appropriateness of different revisions. For instance, the application module 108 can annotate a particular revision by indicating this way of phrasing your idea is used by 80% of authors (to cite merely a representative example). Alternatively, the application module 108 can automatically make a revision based on one or more considerations.

In another text-revision case, the application module 108 can perform a text truncation operation using the translation model 102. For example, the application module 108 can receive original text for presentation on a small-screened viewing device, such as a mobile telephone device or the like. The application module 108 can use the translation model 102 to convert the text, which is treated as an input phrase, to an abbreviated version of the text. In another case, the application module 108 can use this approach to shorten an original phrase so that it is compatible with any message-transmission mechanism that imposes size constraints on its messages, such as a Twitter-like communication mechanism.

In another text-revision case, the application module 108 can use the translation model 102 to summarize a document or phrase. For example, the application module 108 can use this approach to reduce the length of an original abstract. In another case, the application module 108 can use this approach to propose a title based a longer passage of text. Alternatively, the application module 108 can use the translation model 102 to expand a document or phrase.

In another scenario, the application module 108 can perform an expansion of advertising information using the translation model 102. Here, for example, an advertiser may have selected initial triggering keywords that are associated with advertising content (e.g., a web page or other network-accessible content). If an end user enters these triggering keywords, or if the user otherwise is consuming content that is associated with these triggering keywords, an advertising mechanism may direct the user to the advertising content that is associated with the triggering keywords. Here, the application module 108 can consider the initial set of triggering keywords as an input phrase to be expanded using the translation model 102. Alternatively, or in addition, the application module 108 can treat the advertising content itself as the input phrase. The application module 108 can then use the translation model 102 to suggest text that is related to the advertising content. The advertiser can provide one or more triggering keywords based on the suggested text.

The above-described applications are representative and non-exhaustive. Other applications are possible.

In the above discussion, the assumption is made that the output phrase is expressed in the same language as the input phrase. In this case, the output phrase can be considered a paraphrasing of the input phrase. In another case, the mining system 104 and the training system 106 can be used to produce a translation model 102 that converts a phrase in a first language to a corresponding phrase in another language (or multiple other languages).

To operate in a bilingual or multilingual context, the mining system 104 can perform the same basic operations described above with respect to bilingual or multilingual information. In one case, the mining system 104 can establish bilingual result sets by submitting parallel queries within a network environment. That is, the mining system 104 can submit one set of queries expressed in a first language and another set of queries expressed in a second language. For example, the mining system 104 can submit the phrase “rash zoster” to generate an English result set, and the phrase “zoster erupción de piel” to generate a Spanish counterpart of the English result set. The mining system 104 can then establish pairs that link the English result items to the Spanish result items. The aim of this matching operation is to provide a training set which allows the training system 106 to identify links between semantically-related phrases in English and Spanish.

In another case, the mining system 104 can submit queries that combine both English and Spanish key terms, such as in the case of the query “shingles rash erupción de piel.” In this approach, the retrieval module 116 can be expected to provide a result set that combines result items expressed in English and result items expressed in Spanish. The mining system 104 can then establish links between different result items in this mixed result set without discriminating whether the result items are expressed in English or in Spanish. The training system 106 can generate a single translation model 102 based on underlying patterns in the mixed training set. In use, the translation model 102 can be applied in a monolingual mode, where it is constrained to generate output phrases in the same language as the input phrase. Or the translation model 102 can operate in a bilingual mode, in which it is constrained to generate output phrases in a different language compared to the input phrase. Or the translation model 102 can operate in an unconstrained mode in which it proposes results in both languages.

C. Representative Processing Functionality

FIG. 9 sets forth illustrative electrical data processing functionality 900 that can be used to implement any aspect of the functions described above. With reference to FIGS. 1 and 2, for instance, the type of processing functionality 900 shown in FIG. 9 can be used to implement any aspect of the system 100 or the computing functionality 202, etc. In one case, the processing functionality 900 may correspond to any type of computing device that includes one or more processing devices.

The processing functionality 900 can include volatile and non-volatile memory, such as RAM 902 and ROM 904, as well as one or more processing devices 906. The processing functionality 900 also optionally includes various media devices 908, such as a hard disk module, an optical disk module, and so forth. The processing functionality 900 can perform various operations identified above when the processing device(s) 906 executes instructions that are maintained by memory (e.g., RAM 902, ROM 904, or elsewhere). More generally, instructions and other information can be stored on any computer readable medium 910, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 900 also includes an input/output module 912 for receiving various inputs from a user (via input modules 914), and for providing various outputs to the user (via output modules). One particular output mechanism may include a presentation module 916 and an associated graphical user interface (GUI) 918. The processing functionality 900 can also include one or more network interfaces 920 for exchanging data with other devices via one or more communication conduits 922. One or more communication buses 924 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, using electrical data processing functionality, for creating a training set for use in training a statistical translation model, comprising:
constructing queries;
presenting the queries to an electrical data retrieval module, the retrieval module configured to perform a searching operation within an unstructured resource based on the queries;
receiving result sets from the retrieval module, the result sets providing result items identified by the retrieval module as a result of the searching operation; and
performing processing on the result sets to produce a structured training set, the training set identifying pairs of the result items within the result sets,
the training set providing a basis by which an electrical training system can learn the statistical translation model.

2. The method of claim 1, wherein the retrieval module is a search engine and wherein the unstructured resource is a collection resource items accessible via a network environment.

3. The method of claim 2, wherein the network environment is a wide area network.

4. The method of claim 1, wherein said performing processing includes constraining the result items in the result sets based on at least one consideration.

5. The method of claim 4, wherein said constraining includes identifying result items as candidates for pairwise matching based on ranking scores associated with the result items.

6. The method of claim 4, wherein said constraining includes identifying result items as candidates for pairwise matching based on agreement between the result items and respective lexical signatures associated with the result sets.

7. The method of claim 4, wherein said constraining includes identifying result items as candidates for pairwise matching based on similarity scores associated with respective pairs of result items.

8. The method of claim 4, wherein said constraining includes identifying candidates for pairwise matching based on associations between the result items and identified clusters of result items.

9. The method of claim 1, wherein said performing processing comprises, for each result set, identifying pairs of result items within the result set.

10. The method of claim 1, wherein the result items within the result sets correspond to monolingual text content.

11. The method of claim 1, wherein the result items within the result sets correspond to bilingual text content.

12. The method of claim 1, wherein the result items comprise text segments retrieved by the retrieval module from the unstructured resource, the text segments corresponding to excerpts of respective resource items within the unstructured resource.

13. The method of claim 1, further comprising generating the statistical translation model based on the training set and applying the statistical translation model, said applying comprising one of:
using the statistical translation model to expand a search query;
using the statistical translation model to facilitate a document indexing decision;
using the statistical translation model to revise text content; or
using the statistical translation model to expand advertising information.

14. An electrical mining system for creating a training set for use in training a statistical translation model, comprising:
a query presentation module configured to construct queries;
an interface module configured to:
present the queries to a retrieval module, the retrieval module configured to perform a searching operation within an unstructured resource based on the queries; and
receive result sets from the retrieval module, the result sets providing result items identified by the retrieval module as a result of the searching operation; and
a training set preparation module configured to perform processing on the result sets to produce a structured training set, the training set identifying pairs of result items within the result sets,
the training set providing a basis by which an electrical training system can learn the statistical translation model,
the result items within the result sets comprising text segments retrieved by the retrieval module from the unstructured resource, the text segments corresponding to at least sentence fragments of respective resource items within the unstructured resource, the resource items having no pre-identified relation to each other.

15. The mining system of claim 14, wherein the result items within the result sets correspond to monolingual text content, the statistical translation model produced by the training system being used to map between semantically-related phrases within a single language.

16. The mining system claim 14, wherein the result items within the result sets correspond to bilingual text content, the statistical translation model produced by the training system being used to map between phrases within two respective languages.

17. A computer readable medium for storing computer readable instructions, the computer readable instructions providing a mining system when executed by one or more processing devices, the computer readable instructions comprising:
interface logic configured to retrieve result items from an unstructured resource on the basis of queries submitted to the unstructured resource, the unstructured resource corresponding to network-accessible resource items; and
training set preparation logic configured to establish a structured training set from the result items retrieved from the unstructured resource, the training set being constructed in a manner which is agnostic with respect to any similarity among the resource items as respective wholes and any parallelism within sentences contained within the resource items,
the training set providing a basis by which an electrical training system can learn a statistical translation model.

18. The computer readable medium of claim 17, wherein the result items within the result sets comprise text segments retrieved from the unstructured resource, the text segments corresponding to excerpts of respective resource items within the unstructured resource.

19. The computer readable of claim 17, wherein the result items within the result sets correspond to monolingual text content, the statistical translation model produced by the training system being used to map between semantically-related phrases within a single language.

20. The computer readable medium of claim 17, wherein the result items within the result sets correspond to bilingual text content, the statistical translation model produced by the training system being used to map between phrases within two respective languages.
